(19) United States
(12) Patent Application Publication
(10) Pub. No.: US 2025/0061519 A1
(43) Pub. Date: Feb. 20, 2025

(54) SYSTEMS AND METHODS FOR MODULAR SUBSCRIPTION-CENTRIC RESOURCE ARCHITECTURES

(71) Applicant: BANK OF AMERICA CORPORATION, Charlotte, NC (US)

(72) Inventors: Jack Patrick Kelly, New York, NY (US); Michelle Anna-Frances Olsson, Brooklyn, NY (US); Daniel Steven Wennerstrum, Western Springs, IL (US)

(73) Assignee: BANK OF AMERICA CORPORATION, Charlotte, NC (US)

(21) Appl. No.: 18/803,026

(22) Filed: Aug. 13, 2024

Related U.S. Application Data
(60) Provisional application No. 63/532,557, filed on Aug. 14, 2023.

(51) Int. Cl. G06Q 40/06; G06Q 40/02

(52) U.S. Cl. CPC G06Q 40/06; G06Q 40/02

(57) ABSTRACT

Systems, computer program products, and methods are described herein for modular subscription-centric resource architectures. The invention streamlines the user experience through a mobile banking application interface. It's designed to collect a user's resource account data, which includes their preferences, goals, and affiliations with one or more entities. By employing machine learning algorithms, the system analyzes the saved resource account data to ascertain the most fitting subscription tier recommendation. For those new to the platform, essential packages are recommended, while established users are presented with more detailed packages. The dashboard interface showcases the distinct benefits and features of each subscription tier, allowing for informed user selection. Furthermore, within this dashboard interface, there's a section dedicated to customizable bundle selection.

### CROSS-REFERENCE TO RELATED APPLICATIONS

This application is a non-provisional application of and claims priority to U.S. Provisional Application No. 63/532,557, filed on Aug. 14, 2023, the contents of which are also incorporated herein by reference.

### TECHNOLOGICAL FIELD

Example embodiments of the present disclosure relate to systems and methods for modular subscription-centric resource architectures.

### BACKGROUND

Conventional systems and methods for resource utilization often offer certain services and products only to users with a requisite resource amount. These services and products may include specific benefits that may be appealing to users with access to less resources. As such, the present invention includes options for backend system architectures which allow entities to offer certain products and services as a subscription-based option, wherein users opt-in to receive these products and services in return for an amount of resources. As such, Applicant has identified a number of deficiencies and problems associated with systems and methods for modular subscription-centric resource architectures. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for modular subscription-centric resource architectures. As a solution to the shortcomings of conventional systems, the present invention includes a system designed for managing and deploying resources in a single approachable user interface with an included virtual assistant and options for communication with human assistance when necessary or requested. The present invention also includes a number of approaches to increasing user engagement with the provided platform that are centered around the idea of positive engagement feedback, as well as encouraging user engagement via tiered service offerings aimed at families of users who can pool resources to their advantage.

The present invention pertains to a highly adaptive and intuitive resource management system, specifically designed to cater to the evolving demands and requirements of modern consumers. Central to the invention is the integration of a dynamic, subscription-based model which, while grounded in foundational financial wellness themes, provides an enhanced level of customization, ensuring that users have an experience tailored specifically to their individual needs and aspirations.

One of the hallmark features of the present invention is the deployment of subscription tiers, which have been structured to seamlessly address the financial needs of both new customers and longstanding clientele. As users progress on their financial journey, the system offers them an avenue to advance to more comprehensive packages, mirroring the improvement in their financial health. Complementing this feature is the customizable bundles option, which, drawing inspiration from a “choose your own adventure” model, allows users to curate resource services that align with their financial objectives. This selection process is further enhanced by the platform's capacity to integrate its own recommendations, fostering a harmonized alignment between user preference and expert advice.

The invention further includes a virtual assistant. This assistant, operating as a personal aid to users, is equipped with the capability to critically analyze existing subscription payments from a user's resource account, spotlighting any anomalies or unusual transactions. Beyond mere identification, the present system actively recommends cost-saving strategies, even venturing to suggest alternative solutions, such as utility service providers. To bolster the user experience, the platform has incorporated a suite of stress-reduction features. At the core of these features is a comprehensive visual dashboard that amalgamates crucial resource data points, offering users an unobstructed view of the user's financial landscape. Complementing this dashboard is a prompt customer support system, operationalized through advanced chatbots and other superior service mechanisms.

The invention additionally includes security features through specific protective measures that safeguard clients from common pitfalls while rewarding judicious resource expenditure practices. Recognizing the collective financial goals that families often hold, the system introduces family packages, an approach allowing multiple users to amalgamate their resources, streamlining their account experience. This multifaceted platform also harnesses data accumulated during the onboarding process, utilizing it to present intuitive subscription recommendations, as a proactive advisement feature.

The latter features of the invention elevate it from a mere tool to a comprehensive lifestyle companion. dynamic rewards optimization recalibrates rewards in real-time, based on users' expenditure patterns and affiliations with other entities. Furthermore, lifestyle-linked perks and community involvement encouragement grant users the ability to align their resource account habits with their life interests, be it sports or sustainable living, while the integration with social media platforms and the provision of niche investment opportunities further increase engagement.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for systems and methods for modular subscription-centric resource architectures, in accordance with an embodiment of the disclosure;

FIG. 2 illustrates exemplary embodiments of graphical user interfaces for systems and methods for modular subscription-centric resource architectures, in accordance with an embodiment of the disclosure; and

FIG. 3 illustrates a process flow for systems and methods for modular subscription-centric resource architectures, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

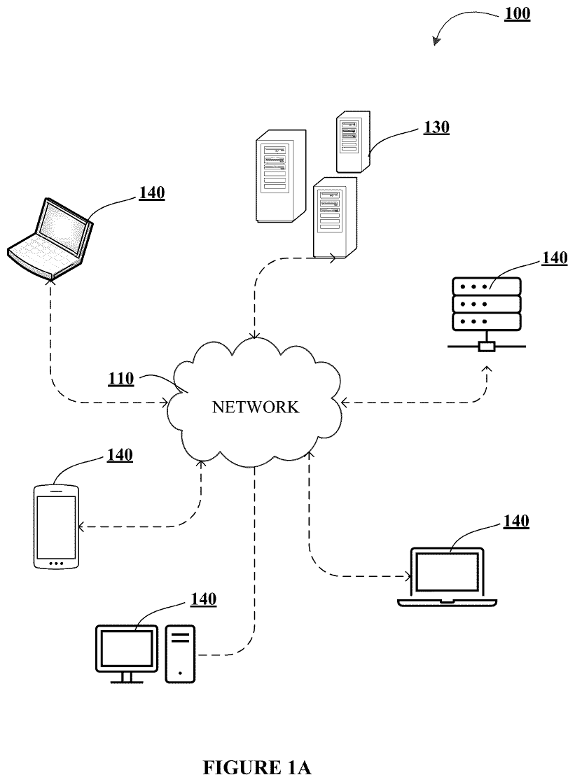

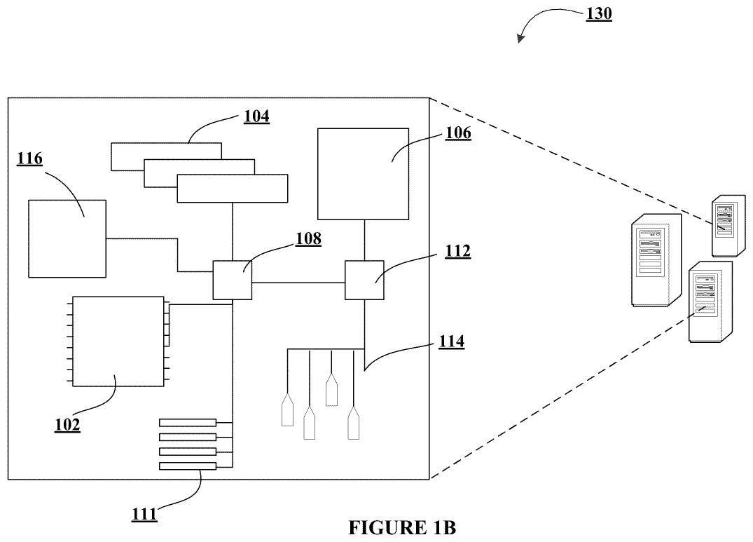

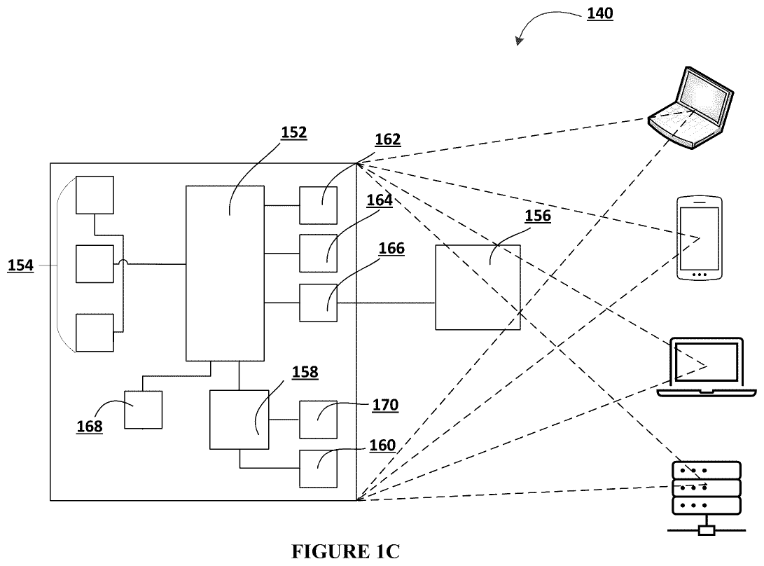

FIGS. 1A-1C illustrate technical components of an exemplary distributed computing environment 100 for systems and methods for modular subscription-centric resource architectures, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

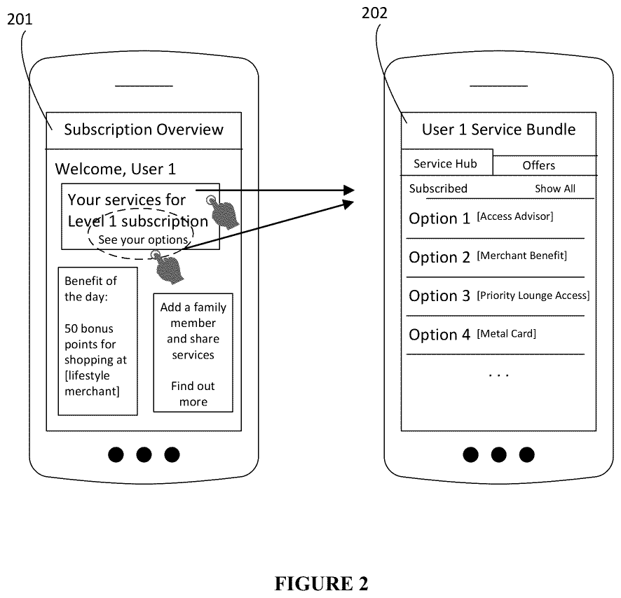

FIG. 2 illustrates exemplary embodiments of graphical user interfaces for systems and methods for modular subscription-centric resource architectures, in accordance with an embodiment of the disclosure. As shown in FIG. 2, the system may generate multiple platform dashboard pages for display via the graphical user interface of an end-point device 140. It is understood that the invention may include many other platform dashboard pages for display via the graphical user interface of the end-point device 140, and that those provided in FIG. 2 are for exemplary purposes only. As indicated by display 201, the platform dashboard may include an overview page displayed immediately after the user logs into an entity mobile application, navigates to a specific section of an entity application, or navigates to a web-based portal provided by the system.

Display 201 includes a section where a subscription overview may be displayed such that the user can see their selected services and “level,” which might include various resource account related services offered by the entity. For instance, the display 201 may include a welcome message with their name, depicted as “Welcome, User 1” in FIG. 2, displayed toward the top of the platform dashboard landing page. Just below this section, there is a clickable section dedicated to showing the user's “level,” wherein the level may comprise a tier associated with the subscription package selected by the user. It is understood that the level or tier may be designed to indicate user's progress toward a specific goal, the amount of the time the user has been enrolled in a benefit program, the amount of resources the user keeps in their account, or may indicate further benefits that the user may obtain or purchase as a part of their subscription (e.g., level 2 may allow additional services or perks compared to level 1, or the like).

As further shown on display 201 of FIG. 2, the initial landing page may include other information tailored to the user. For instance, this may include a dynamic “benefit of the day” wherein the user can claim a certain number of resources or reward points for shopping with a merchant that the system has intelligently identified, either based on the user's resource spend history or provided information, that they may have an interest in. For instance, the user's purchase history may indicate an interest in green or environmentally conscientious living, and the system may offer additional bonus reward points for shopping with a merchant that is known as aligning with this lifestyle.

In other embodiments, the information tailored to the user may include a specific time period in which resource accrual will be multiplied, such as a “bonus day” set to a specific day of the year, day of the week, or the like. In other embodiments, the information tailored to the user may be one or more resource accrual opportunities associates with one or more merchants, product types, service types, or the like, that the system may determine the user is interested in based on a resource activity history associated with their resource account (e.g., the user may have purchased a product from Merchant 1, Merchant 1 may be a partner of the entity managing the system, and the system may automatically display an offer to accrue resources in Amount X if they shop at Merchant 1 and activate the specific offer, or the like).

It is understood that the system may be linked to one or more instruments or accounts of the user. For instance, the user may maintain multiple types of resource accounts or instruments via the managing entity of the system, or some resource processor partnered with the managing entity. In some instances, each of these resource accounts or instruments may have resource accrual programs associated with them that allow the user to accrue airline miles, points, discounts, dollars, or the like. It is understood that the present system may combine each of these accruals into a common resource type and display a total accrued resource value via the display of the end-point device 140. In other embodiments, offers may include linking family accounts under the subscription-based service, in order that the user's family members can share subscription services under a family bundle. This may be offered as an encouragement to the user to grow the userbase and in hopes of onboarding user family members at an early stage in their resource account development. In some embodiments, the system may intelligently infer that the user has one or more family members by nature of analyzing resource spend history, or by nature of an onboarding survey when the user signs up for the subscription based services.

The present invention pertains to a highly adaptive and intuitive resource management system, specifically designed to cater to the evolving demands and requirements of modern consumers. Central to the invention is the integration of a dynamic, subscription-based model which, while grounded in foundational financial wellness themes, provides an enhanced level of customization, ensuring that users have an experience tailored specifically to their individual needs and aspirations.

One of the hallmark features of the present invention is the deployment of subscription tiers, or “levels,” which have been structured to seamlessly address the financial needs of both new customers and longstanding clientele. As users progress on their financial journey, the system offers them an avenue to advance to more comprehensive packages, mirroring the improvement in their financial health. Complementing this feature is the customizable bundles option, which, drawing inspiration from a “choose your own adventure” model, allows users to curate resource services that align with their financial objectives. This selection process is further enhanced by the platform's capacity to integrate its own recommendations, fostering a harmonized alignment between user preference and expert advice.

The invention further includes a virtual assistant. This assistant, operating as a personal aid to users, is equipped with the capability to critically analyze existing subscription payments from a user's resource account, spotlighting any anomalies or unusual transactions. Beyond mere identification, the present system actively recommends cost-saving strategies, even venturing to suggest alternative solutions, such as utility service providers. To bolster the user experience, the platform has incorporated a suite of stress-reduction features. At the core of these features is a comprehensive visual dashboard that amalgamates crucial resource data points, offering users an unobstructed view of the user's financial landscape. Complementing this dashboard is a prompt customer support system, operationalized through advanced chatbots and other superior service mechanisms. Access to the virtual assistant may be provided through a user interface such as display 201 or 202.

The invention additionally includes security features through specific protective measures that safeguard clients from common pitfalls while rewarding judicious resource expenditure practices. Recognizing the collective financial goals that families often hold, the system introduces family packages, an approach allowing multiple users to amalgamate their resources, streamlining their account experience. This multifaceted platform also harnesses data accumulated during the onboarding process, utilizing it to present intuitive subscription recommendations, as a proactive advisement feature.

The latter features of the invention elevate it from a mere tool to a comprehensive lifestyle companion. dynamic rewards optimization recalibrates rewards in real-time, based on users' expenditure patterns and affiliations with other entities. Furthermore, lifestyle-linked perks and community involvement encouragement grant users the ability to align their resource account habits with their life interests, be it sports or sustainable living, while the integration with social media platforms and the provision of niche investment opportunities further increase engagement.

As further indicated by FIG. 2, clicking, tapping, or otherwise interacting with certain sections of display 201 may prompt the system to transition the graphical user interface of end-point device 140 to display different information, such as display 202. It is understood that the action of clicking, tapping, or interacting with the display of end-point device 140 may also prompt a device engagement or re-engagement action, such as haptic feedback, a colorful animation, an auditory transmission, or the like, that the user may find pleasing. As such, interacting with the display of the end-point device 140 may be encouraged by positive feedback in one or more fashions.

As shown on display 202, the system may display a more detailed overview specific to the user's subscription, such as a list of all subscribed service options or perks are shown and described for convenience of the user. For instance, as shown in display 202, option 1 may include access to a financial advisor (e.g., the user may access a bespoke financial service appointment akin to those available to larger resource accounts, but on a limited basis, such as once per quarter, or once per year, or the like). An additional subscription option may include option 2, such as a merchant benefit for an existing subscription service, wherein the entity partners with a merchant that the user already subscribes to in order to offer a discount or lower price for that existing service. Also shown is option 3, which may include priority lounge access, such as in an airport or the like. Finally, option 4 shown in the exemplary display 202 is the option to order a metal resource instrument card that signifies the user's subscription level and provides a sense of exclusivity to the user as a part of their subscription level.

As further indicated by display 202 of FIG. 2, the display may include an “offers” tab where the user can navigate to in order to see different offers for their subscription level which they may substitute in or out for existing selected options. In this way, the user may not only visualize currently selected options, but also discover new ways to utilize their subscription level, or even upgrade their subscription level to allow for more options to be selected at one time. In this way, an “a la carte” menu of subscription services is provided that the user can choose from to apply to their resource account.

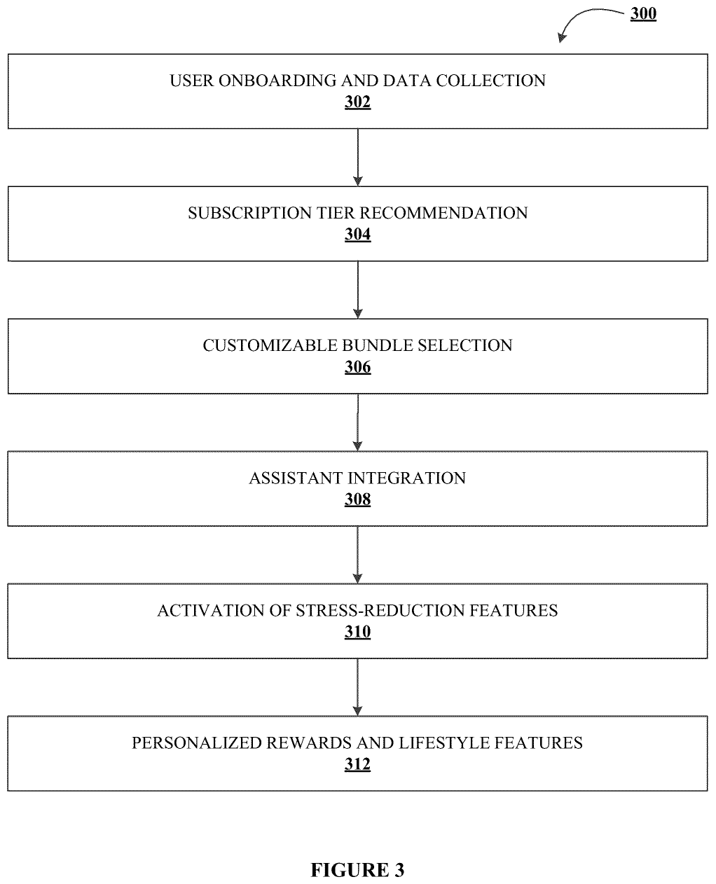

FIG. 3 illustrates a process flow for systems and methods for modular subscription-centric resource architectures, in accordance with an embodiment of the disclosure. The inception of the user experience begins with the onboarding and data collection phase, as shown in block 302. Upon downloading and installing the mobile banking application, the user is walked through a meticulously designed registration process. This requires them to input personal and financial information, preferences, goals, and any existing affiliations with other entities or institutions. This essential data is securely captured and stored by the system, laying the foundation for a tailored user experience.

Building upon this foundation, the system's algorithms are employed in analyzing the user's resource account situation. This analysis is pivotal in determining the subscription tier recommendation, as shown in block 304. For new entrants, the system typically suggests essential packages, while those exhibiting longstanding financial stability are presented with more intricate options. Through the dashboard, the intrinsic benefits and features of each tier are laid bare, granting the user the liberty to make an informed choice or even consider future upgrades.

The core foundation of the provided mobile application is based on popular and robust coding languages. For the front-end (the user interface), languages such as Swift for iOS devices and Kotlin for Android devices are utilized. The back-end (server-side), which handles the data processing, is constructed using Python or Node.js, known for their scalability and efficiency in financial applications. The application layer serves as the hub of the user experience. Built on a Model-View-Controller (MVC) architecture, it ensures that the user interface, data, and the software logic remain separated, thus promoting modularity and easy maintenance. When the user starts the onboarding process, the application communicates with the back-end servers to process the inputs. Here, APIs (Application Programming Interfaces) play a critical role, facilitating the interaction between the user's device and the centralized, back-end system of the invention, ensuring real-time data updates and synchronization.

Safety and speed are paramount in any mobile application, particularly those that deal with the management of user resources and accounts. Therefore, the network layer is constructed on top of a secure sockets layer (SSL) encryption, ensuring that all data transfers between the application and the servers are encrypted and safe from any eavesdropping or man-in-the-middle attacks. Content Delivery Networks (CDNs) are implemented to improve the application's performance, reducing the latency by strategically positioning the data in various locations globally. This layer focuses on the storage, retrieval, and manipulation of user data. A relational database management system (RDBMS) such as PostgreSQL or MySQL is employed to organize and store the vast amounts of user data, including personal and financial information, preferences, goals, etc. Data integrity and consistency are maintained using techniques such as ACID (Atomicity, Consistency, Isolation, Durability) transactions. Furthermore, to optimize performance and data access speed, caching mechanisms using tools like Redis or Memcached are incorporated.

To maintain utmost security, particularly in the data layer, strategies like tokenization of sensitive financial data and regular penetration testing are implemented. Moreover, user data is frequently backed up in encrypted formats, ensuring data durability and quick recovery in case of unforeseen contingencies. As the user navigates through the mobile application, it is understood that their experience may be continuously refined and tailored based on real-time analytics and feedback. The backend systems use machine learning models to analyze user behavior and preferences, dynamically offering them subscription banking opportunities that align with their financial goals and needs. By integrating these layers seamlessly, the mobile banking app not only ensures a streamlined onboarding process but also offers a dynamic, secure, and tailored subscription banking experience to its users.

With the user's chosen subscription in place, the dashboard transitions into the “Customizable Bundle Selection” phase, as shown in block 306. Emulating the experience of a “choose your own adventure” interface, users are empowered to sift through a plethora of services or perks, each shaped to fit individual objectives. In an added layer of personalization, the system, relying on the reservoir of data from the initial phase, proactively suggests potential combinations tailored to the user's needs and preferences.

Upon the user selecting a subscription, the mobile app's frontend, built using frameworks like React Native or Flutter, dynamically adjusts the user interface (UI). These frameworks allow for responsive UIs that can adapt based on the user's interactions. The transition to the “Customizable Bundle Selection” phase utilizes animations and transitions, enhancing user experience and making navigation intuitive. Services or perks available for selection are stored in a structured database, with tags and attributes that describe their nature and applicability. These attributes might include categories like ‘savings’, ‘investment’, ‘luxury’, or ‘daily use’. When rendering in the application, a grid or list layout, populated through API calls to the backend, displays these options. In some embodiments, a loading mechanism ensures that not all options are loaded simultaneously, promoting faster load times and efficient data usage.

It is understood that the user experience is achieved through conditional logic implemented in the code. Depending on the user's selections, the interface presents subsequent options, using JavaScript or a similar scripting language, to guide the user down a path tailored to their choices. For instance, if a user picks a ‘savings’ subscription, the next set of options might revolve around interest rates, associated entities, or savings programs. Based on the initial data reservoir from the onboarding phase, a recommendation engine is employed. This can be built using libraries like TensorFlow or Scikit-learn. The engine processes the user's financial data, preferences, and past behaviors, running them against the attributes of available services or perks. By calculating suitability scores for each service, the algorithm determines and suggests the most relevant combinations to the user. One common approach to create a suitability score is to use a 0-100 scale, where 0 represents no suitability (or alignment) and 100 represents perfect suitability (or alignment) between the user's preferences and the available subscription bundle options.

In various embodiments, factors considered in the score may include historical preferences, such as past choices made by the user on the mobile application or with regard to the products or services they currently subscribe to from the entity or other known entities. Additionally, the system may employ the use of stated preferences, or preferences explicitly indicated during onboarding or through settings on the mobile application. Additionally, the system m ay account for how often the user uses certain features, time spent on particular sections, or the like. Equally relevant may be conducting a comparative analysis, or determining how similar bundles or services fared with users of a similar description. This data may be indicated by length of time other users have remained subscribed to certain products or services in their subscription bundles, or may be obtained through survey feedback or general application feedback mechanisms such as ‘like’ or ‘thumbs up’ buttons placed around the application user interface. Finally, the system may also infer implicit feedback. For instance, in some embodiments, whether the user has ignored or skipped similar recommendations in the past may be instructive as to which related options the user may be interested in the future.

An example of an intelligent recommendation may include a perk or service related to a ‘travel enthusiast’ category. For instance, the user may have shown interest in the ‘travel enthusiast’ category during their onboarding. They may have frequently booked trips, looked up travel insurance, and spent significant time on travel-related blog posts within the mobile application or other linked social media applications. The system may recommend a ‘premium travel bundle’ which offers exclusive travel deals, free travel insurance for short trips, and access to a curated list of travel blogs or booking services via the mobile application. In terms of determining metrics for this inference, the system may utilize historical preferences, wherein if the user booked several trips in the past year, the system may assign a number of points (+25 points, or the like). Similarly, the system may utilize stated preferences if the user indicated ‘traveling’ as a top hobby during onboarding (+20 points, or the like). The system may utilize behavioral data, where if the user spends, on average, 15 minutes every week on travel-related sections of the app, the system may assign additional points to the travel category (+15 points, or the like). In terms of comparative analysis, the system may determine that 85% of users with similar data as the user have shown a positive response to the ‘premium traveler's bundle’ (+20 points, or the like). Finally, the system may also account for implicit feedback, wherein the user has never skipped or ignored travel bundle recommendations (+20 points, or the like). In this exemplary embodiments, the total suitability score for the travel category recommendation would be 100/100, indicating a strong likelihood that the subscription recommendation would be viewed positively by the user if provided. Based on this exemplary calculation, the ‘premium traveler's bundle’ actually has a perfect suitability score for the user, making it highly likely that they would be interested in this particular subscription bundle option. The system, thus, would prioritize showcasing this bundle to the user when the user navigates to the bundle selection phase.

The user's choices, combined with the recommendations made by the system, are continually stored and updated in real-time in the system's relational database. This ensures that any change made by the user is instantly reflected across all devices and sessions. Technologies like WebSockets might be used to achieve real-time two-way communication between the client and server. To further enhance the user experience, the system incorporates a feedback loop. Every time a user selects, declines, or modifies a suggestion, this action is logged. Over time, these logs are analyzed, allowing the recommendation engine to refine its algorithms, thereby improving the accuracy and relevance of its suggestions in subsequent interactions.

By merging robust coding practices with advanced system engineering techniques, the mobile app ensures an engaging and highly personalized journey for the user, truly emulating the feel of a “choose your own adventure” narrative while maintaining efficiency and precision.

The system, understanding the value of proactive financial insights, integrates the financial assistant feature once the user's preferences are set, as indicated in block 308. The dashboard transforms into a hub of real-time financial analyses. Subscription payments, their patterns, and any anomalies in them are displayed with clarity. Should there be deviations from the user's typical spending patterns or any unusual costs, they are promptly highlighted. To aid the user further, the system dynamically presents actionable recommendations, ensuring that the most optimized financial routes are always within reach.

Understanding the stress often associated with financial management, the dashboard seamlessly incorporates stress-reduction features, as indicated in block 310. A central area of the dashboard stands as a beacon of consolidated financial data, providing users with a holistic and easy-to-understand overview of their finances. For those moments when users need assistance, integrated chatbots and customer support options are strategically positioned, offering immediate access. Additionally, the protective measures incorporated into the system vigilantly monitor the user's actions, notifying them of potential pitfalls while concurrently rewarding astute decisions.

To encapsulate the experience, the dashboard embraces the user's lifestyle and spending patterns, as shown in block 312. By analyzing both their habits and data from other associated banks, the rewards section of the dashboard remains in a state of flux, dynamically updating to ensure the most optimized benefits. Users are presented with a myriad of options, from sports-themed rewards to environmental, social, and governance (ESG) community initiatives, all aligned with their passions. For those keen on sharing their milestones, social media integration options lie embedded in the dashboard. Furthermore, an investment portal curates and presents opportunities that resonate with the user's stated interests, ensuring that every interaction with the dashboard remains both useful and personalized.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for modular subscription-centric resource architectures, the system comprising:
at least one non-transitory storage device; and
at least one processor coupled to the at least one non-transitory storage device, wherein the at least one processor is configured to:
facilitate a user registration process via a mobile banking application interface to collect user's resource account data, comprising preferences, goals, and affiliations with one or more entities;
store the resource account data in the at least one non-transitory storage device;
utilize one or more machine learning algorithms to analyze the stored resource account data to determine an appropriate subscription tier recommendation, wherein essential packages are suggested for newer users and intricate packages for established users;
display the intrinsic benefits and features of each subscription tier via a dashboard interface for user selection; and
enable a customizable bundle selection section within the dashboard interface, wherein the user can select from a range of services tailored to individual objectives, and proactively suggest service combinations based on the user's resource account data.

2. The system of claim 1, wherein the machine learning algorithms are further configured to update the subscription tier recommendation dynamically based on real-time changes in the user's resource account data.

3. The system of claim 1, wherein the dashboard interface further comprises a visual representation of the user's progress towards their financial goals, including alerts for reaching specific milestones or falling behind.

4. The system of claim 1, wherein the customizable bundle selection section allows the user to compare potential service combinations side-by-side before finalizing their selection.

5. The system of claim 1, wherein the mobile banking application interface includes a virtual assistant configured to provide real-time financial advice and recommendations based on the user's current subscription tier and resource account data.

6. The system of claim 1, wherein the processor is further configured to generate and display personalized offers and discounts from third-party merchants, based on the user's selected subscription tier and preferences.

7. The system of claim 1, wherein the dashboard interface includes an interactive tutorial that guides new users through the subscription selection and customization process.

8. A computer program product for modular subscription-centric resource architectures, the computer program product comprising a non-transitory computer-readable medium comprising code causing an apparatus to:
facilitate a user registration process via a mobile banking application interface to collect user's resource account data, comprising preferences, goals, and affiliations with one or more entities;
store the resource account data in the at least one non-transitory storage device;
utilize one or more machine learning algorithms to analyze the stored resource account data to determine an appropriate subscription tier recommendation, wherein essential packages are suggested for newer users and intricate packages for established users;
display the intrinsic benefits and features of each subscription tier via a dashboard interface for user selection; and
enable a customizable bundle selection section within the dashboard interface, wherein the user can select from a range of services tailored to individual objectives, and proactively suggest service combinations based on the user's resource account data.

9. The computer program product of claim 8, wherein the machine learning algorithms are further configured to update the subscription tier recommendation dynamically based on real-time changes in the user's resource account data.

10. The computer program product of claim 8, wherein the dashboard interface further comprises a visual representation of the user's progress towards their financial goals, including alerts for reaching specific milestones or falling behind.

11. The computer program product of claim 8, wherein the customizable bundle selection section allows the user to compare potential service combinations side-by-side before finalizing their selection.

12. The computer program product of claim 8, wherein the mobile banking application interface includes a virtual assistant configured to provide real-time financial advice and recommendations based on the user's current subscription tier and resource account data.

13. The computer program product of claim 8, wherein the processor is further configured to generate and display personalized offers and discounts from third-party merchants, based on the user's selected subscription tier and preferences.

14. The computer program product of claim 8, wherein the dashboard interface includes an interactive tutorial that guides new users through the subscription selection and customization process.

15. A method for modular subscription-centric resource architectures, the method comprising:
facilitate a user registration process via a mobile banking application interface to collect user's resource account data, comprising preferences, goals, and affiliations with one or more entities;
store the resource account data in the at least one non-transitory storage device;
utilize one or more machine learning algorithms to analyze the stored resource account data to determine an appropriate subscription tier recommendation, wherein essential packages are suggested for newer users and intricate packages for established users;
display the intrinsic benefits and features of each subscription tier via a dashboard interface for user selection; and
enable a customizable bundle selection section within the dashboard interface, wherein the user can select from a range of services tailored to individual objectives, and proactively suggest service combinations based on the user's resource account data.

16. The method of claim 15, wherein the machine learning algorithms are further configured to update the subscription tier recommendation dynamically based on real-time changes in the user's resource account data.

17. The method of claim 15, wherein the dashboard interface further comprises a visual representation of the user's progress towards their financial goals, including alerts for reaching specific milestones or falling behind.

18. The method of claim 15, wherein the customizable bundle selection section allows the user to compare potential service combinations side-by-side before finalizing their selection.

19. The method of claim 15, wherein the mobile banking application interface includes a virtual assistant configured to provide real-time financial advice and recommendations based on the user's current subscription tier and resource account data.

20. The method of claim 15, wherein the processor is further configured to generate and display personalized offers and discounts from third-party merchants, based on the user's selected subscription tier and preferences.
